(19) United States
(12) Patent Application Publication
(10) Pub. No.: US 2014/0306847 A1
(43) Pub. Date: Oct. 16, 2014

(54) ANTENNA CLIP AND ELECTRONIC DEVICE EMPLOYING THE SAME

(71) Applicants: FIH (Hong Kong) Limited, Kowloon (HK); SHENZHEN FUTAIHONG PRECISION INDUSTRY CO., LTD., Shenzhen (CN)

(72) Inventor: ZHI-YUN WANG, Shenzhen (CN)

(73) Assignees: FIH (HONG KONG) LIMITED, Kowloon (HK); SHENZHEN FUTAIHONG PRECISION INDUSTRY CO., LTD., Shenzhen (CN)

(21) Appl. No.: 14/076,407

(22) Filed: Nov. 11, 2013

(30) Foreign Application Priority Data
Apr. 15, 2013 (CN) 2013101284646

(51) Int. Cl. H01Q 1/24; F16L 3/13

(52) U.S. Cl. CPC H01Q 1/241; F16L 3/13
USPC 343/702; 248/74.2

(57) ABSTRACT

An antenna clip includes a clip body and a fixing body extended from the clip body. The clip body includes a first wall and a second wall formed by bending and extending the first wall. The first wall is corresponded to the second wall and stretches relative to the second wall. The first wall includes at least one first resisting arm located between the first wall and the second wall. An electronic device employing the antenna clip is also disclosed.

### BACKGROUND

1. Technical Field

The present disclosure relates to an antenna clip and an electronic device employing the antenna clip.

2. Description of Related Art

Electronic devices such as mobile phones have mounted antennas therein. The antenna is made of copper or aluminum material. In some electronic devices, the antennas are mounted on a motherboard of the electronic device and are directly electrically connected to the motherboard to feed signals. However, the antennas mounted on the motherboard occupy a large space of the motherboard. In some other electronic devices, the antennas are electrically connected to the motherboard via cables. The cables are secured to a housing by glue or hot melting. However, the secured antennas are undetachable, thus can be difficult to replace. Therefore, the efficiency of the manufacturing may be affected and the cost may be increased.

### BRIEF DESCRIPTION OF THE DRAWINGS

Many aspects of the disclosure can be better understood with reference to the following figures. The components in the figures are not necessarily drawn to scale, the emphasis instead being placed upon clearly illustrating the principles of the disclosure. Moreover, in the drawings, like reference numerals designate corresponding parts throughout the several views.

FIG. 1 is an exploded view of an exemplary embodiment of an electronic device employing an antenna and at least one antenna clip.

FIG. 2 is an isometric view of the antenna clip of the electronic device shown in FIG. 1.

FIG. 3 is another isometric view of the antenna clip of FIG. 2.

FIG. 4 is an assembled view of the electronic device shown in FIG. 1.

FIG. 5 is a schematic view of cables of the antenna mounted in the antenna clip shown in FIG. 1.

### DETAILED DESCRIPTION

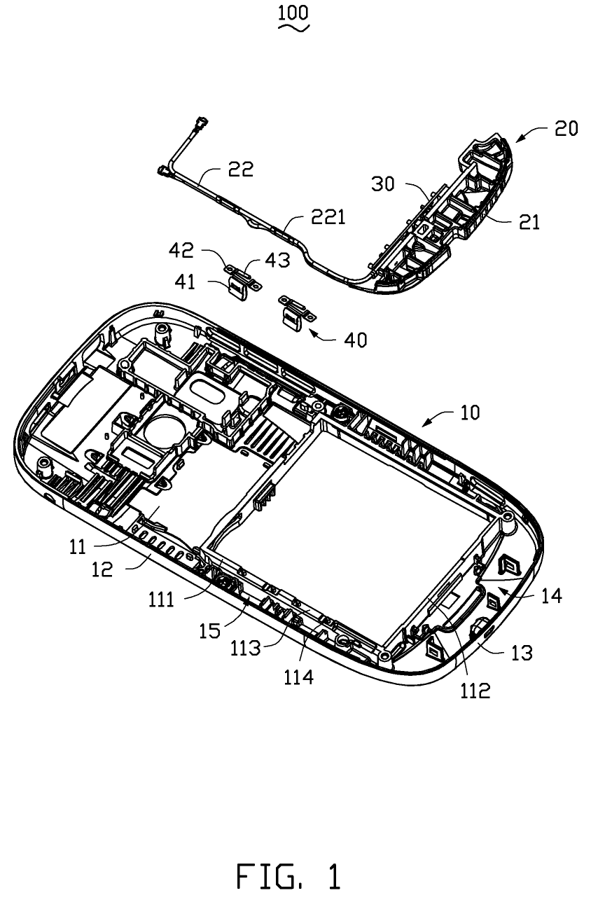

FIG. 1 shows an electronic device 100 according to an exemplary embodiment. In the embodiment the electronic device 100 can be a mobile phone or a tablet computer. The electronic device 100 includes a housing 10, a main circuit board (not shown), an antenna 20, a subsidiary circuit board 30, and at least one antenna clip 40. The antenna 20 is mounted in the housing 10 and is secured by the antenna clip 40. The antenna 20 is electronically connected to the main circuit board to feed signals and be grounded.

The housing 10 includes a bottom wall 11, two opposite sidewalls 12, and two opposite end walls 13. The two end walls 13 are connected to the two sidewalls 12 respectively. The sidewalls 12 and the end walls 13 cooperatively surround a peripheral edge of the bottom wall 11. The housing 10 further defines a rectangular groove for receiving a battery, two first partition walls 111 parallel with the sidewalls 12 and two second partition walls 112 parallel with the end walls 13. The two first partition walls 111 and the two second partition walls 112 cooperatively surround the rectangular groove. A receiving groove 14 is formed between one second partition wall 112 and one end wall 13 adjacent the second partition wall 112. A mounting groove 15 is formed between one first partition wall 111 and one sidewall 12 adjacent the first partition wall 111. The first partition wall 111 defines two recesses 113 therein, and a plurality of posts 114 protruding from a bottom surface of the recesses 113. The two recesses 113 are adjacent to each other, and are recessed towards the bottom wall 11. There are two posts 114 disposed in each recess 13.

The antenna 20 includes a main portion 21 and two cables 22. The antenna 20 is electrically connected to the subsidiary circuit board 30 and received in the receiving groove 14 together with the subsidiary circuit board 30. The two cables 22 are juxtaposed and received in the mounting groove 15. The two cables 22 include two opposite ends (not labeled), one end of the cables 22 are electrically connected to the subsidiary circuit board 30 to electrically connect to the main portion 21. The other end of the cables 22 are electrically connected to the main circuit board (not shown). Each cable 22 includes several metal rings 221 spaced with each other.

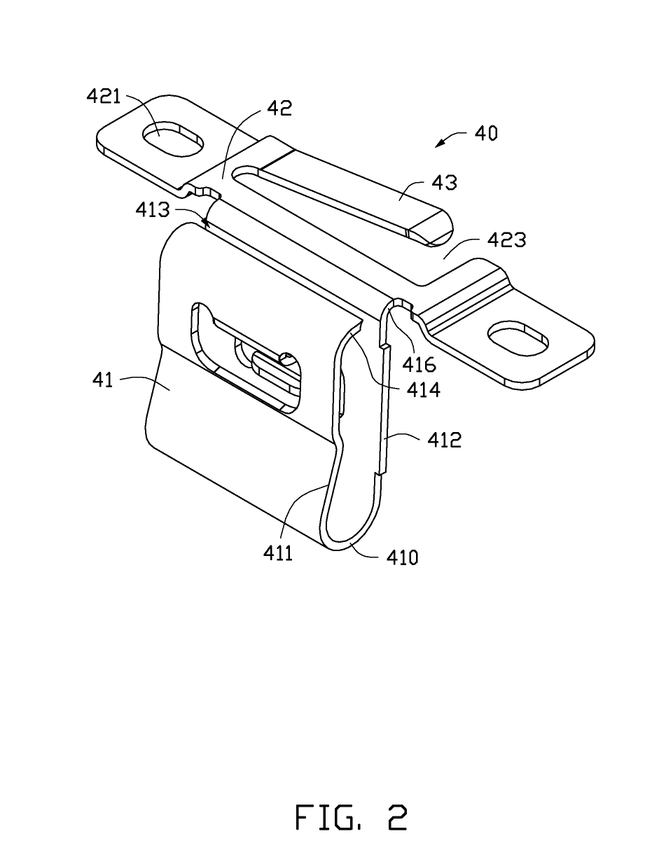

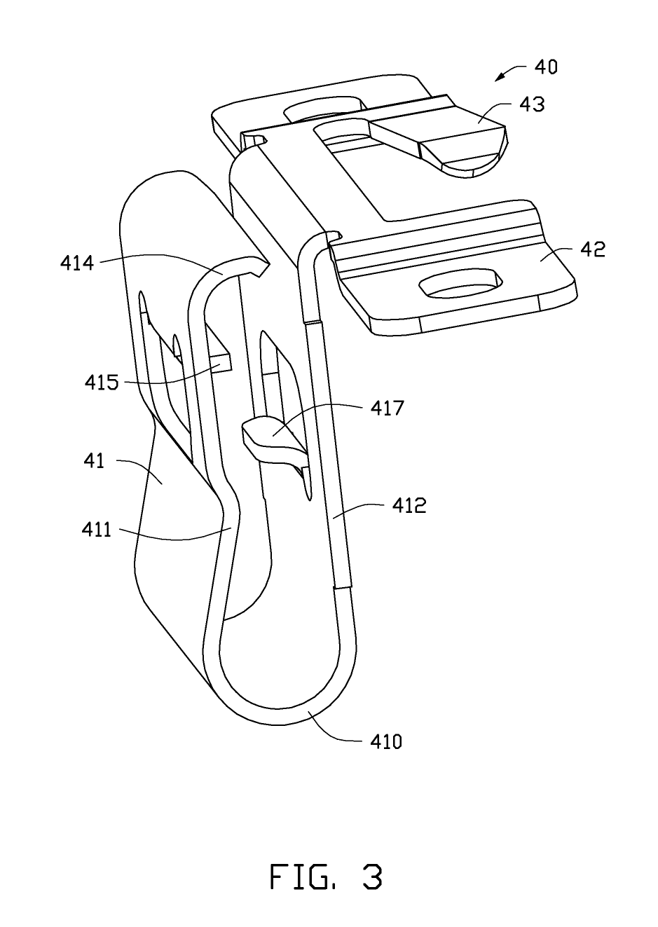

FIGS. 2 and 3 show an exemplary embodiment of the antenna clip 40. In the present embodiment, the electronic device 100 includes two antenna clips 40. Each antenna clip 40 is integrally made of metal sheet by stamping procedure. Each antenna clip 40 includes a clip body 41 and a fixing body 42 integrally connected to each other. The clip body 41 includes a base 410, a sheet-shaped first wall 411 and a sheet-shaped second wall 412. The clip body 41 is U-shaped, and the first wall 411 and the second wall 412 are integrally connected to opposite sides of the base 410, opposite to each other. The base 410 is an arcuate portion, and provides tension force between the first wall 411 and the second wall 412.

The first wall 411 includes a limiting end 414 and a first resisting arm 415. The second wall 412 includes a connecting end 416 and a second resisting arm 417. An opening 413 is formed between the limiting end 414 and the connecting end 416, opposite to the base 410. The opening 413 can be expanded by stretching the limiting end 414 of the first wall 411 apart from the connecting end 416 of the second wall 412. The limiting end 414 is bent towards the second wall 412. The first resisting arm 415 is formed by cutting off a central portion of the first wall 411 and is protruding from the first wall 411 towards the second wall 412. The first resisting arm 415 is a rectangular bent piece. The first resisting arm 415 has a side integrally connecting to the first wall 411 and an opposite side extending towards the second wall 412, thus cooperatively defining a receiving space with the limiting end 414 to receive cable. The second resisting arm 417 is formed by cutting off a central portion of the second wall 412 and is protruding from the second wall 412 towards the first wall 411. The second resisting arm 417 is a rectangular bent piece. The second resisting arm 417 has a side integrally connecting to the second wall 412 and an opposite side extending towards the first wall 411. The second resisting arm 417 is spaced away from the first resisting arm 415, and thus forms a receiving space in the clip body 41 divided into several partitions by the first resisting arm 415 and the second resisting arm 417 for respectively receiving cables therein. Therefore, the first resisting arm 415 and the second resisting arm 417 are located between the first wall 411 and the second wall 412.

The fixing body 42 is bent extending outwardly from the connecting end 416, and has two positioning holes 421 defined in opposite ends. The fixing body 42 defines a cutout 423 between the two opposite ends. A connecting arm 43 is positioned in the cutout 423. The connecting arm 43 includes one end connecting to the fixing body 42, and an opposite end tilting and extending towards to the end of the fixing body 42. The fixing body 42 and the connecting arm 43 are for mounting the antenna clip 100 to other elements of the electronic device 100, such as a cover (not shown). The connecting arm 43 and the clip body 41 are disposed on opposite sides of the fixing body 42, and are extending in opposite directions.

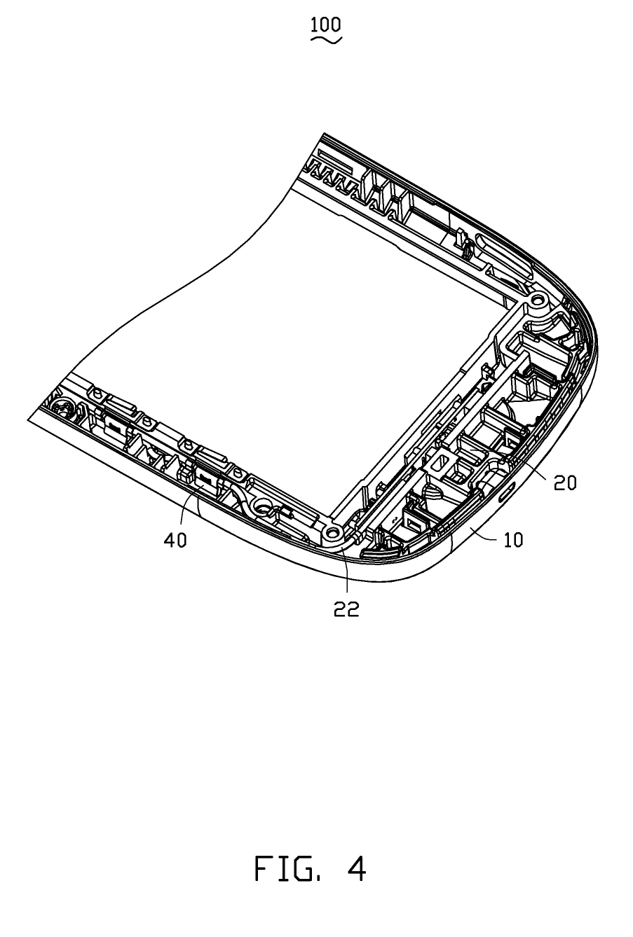

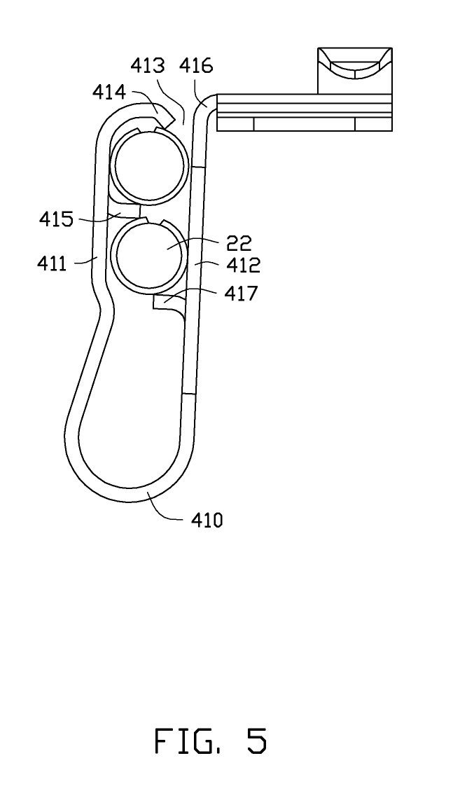

FIGS. 4 and 5 show that the two antenna clips 40 are mounted in the mounting groove 15, the positioning holes 421 of the antenna clips 40 are engaged with the posts 114 on the first partition wall 111 and fixed by hot melting technology. Thus, the antenna clip 40 is secured on the housing 10, with the second wall 412 adjacent to the first partition wall 111. The main portion 21 and the subsidiary circuit board 30 are received in the receiving groove 14. The two cables 22 are routed via the receiving groove 14 and the mounting groove 15 to electronically connect the antenna 20 to the main circuit board. The first wall 411 is stretched to open the opening 413. One cable 22 is moved through the opening 413 and then is clamped by the first wall 411 and the second wall 412, with the metal ring 221 resisting against the first and second resisting arm 415, 417. The other cable 22 is placed between the first resisting arm 415 and the limiting end 414, with the metal ring 221 resisting against the first resisting arm 415 and the limiting end 414. Then, the first wall 411 is released, the cables 22 are elastically clamped by the first wall 411 and the second wall 412, and the cable 22 adjacent to the opening 413 is retained in the clip body 41 by the limiting end 411, thus preventing the cables 22 sliding out from the opening 413. The connecting arm 43 is connected to a ground portion of the main circuit board, the metal rings 221 of the cables 22 are electronically connected to the metal antenna clip 40, therefore the antenna 20 is connected to ground.

The electronic device 100 detachably mounts the cables 22 of the antenna 20 via the antenna clips 40, thus simplifies the process of mounting the antenna 20 to the housing 10 and reduces manufacturing time. When needs to detach the antenna 20, the first wall 411 can be manually stretched to detach the cables 22, which is easy.

In another embodiment, the cable 22 can also be received between the second resisting arm 417 and the base 410.

In another embodiment, the quantity of the first resisting arm 415 and the second resisting arm 417 can be increased when needed.

In another embodiment, the first resisting arm 415 and the second resisting arm 417 can be in other shapes.

It is believed that the exemplary embodiment and its advantages will be understood from the foregoing description, and it will be apparent that various changes may be made thereto without departing from the spirit and scope of the disclosure or sacrificing all of its advantages, the examples hereinbefore described merely being preferred or exemplary embodiment of the disclosure.

What is claimed is:

1. An antenna clip for clipping at least one antenna cable, comprising:
a clip body comprising a base, a first wall and a second wall, the first wall and the second wall integrally connected to opposite ends of the base and facing towards each other, the first wall comprising at least one first resisting arm protruding from a central portion thereof towards the second wall, and a limiting end bent towards the second wall; the second wall comprising at least one second resisting arm protruding from a central portion thereof towards the first wall, and a connecting end; a receiving space formed in the clip body being divided into several partitions by the first resisting arm and the second resisting arm for respectively clipping the at least one antenna cables in separate partitions;
a fixing body connected to the connecting end of the second wall for assembling the antenna clip to other structures.

2. The antenna clip as claimed in claim 1, wherein an opening is formed between the limiting end and the connecting end, the opening can be expanded by stretching the limiting end apart from the connected end.

3. The antenna clip as claimed in claim 2, wherein the limiting end is bent towards the second wall, the fixing body is bent extending outwardly from the connecting end.

4. The antenna clip as claimed in claim 2, wherein the quantity of the first resisting arm is one, the first resisting arm is formed by cutting off a central portion of the first wall and has a side integrally connecting to the first wall and an opposite side extending towards the second wall, thus cooperatively forming a receiving space with the limiting end.

5. The antenna clip as claimed in claim 4, wherein the quantity of the second resisting arm is one, the second resisting arm is formed by cutting off a central portion of the second wall and has a side integrally connecting to the second wall and an opposite side extending towards the first wall, thus cooperatively forming a receiving space with the first resisting arm.

6. The antenna clip as claimed in claim 5, wherein the second resisting arm is spaced away from the first resisting arm, the first resisting arm and the second resisting arm are located between the first wall and the second wall.

7. The antenna clip as claimed in claim 2, wherein the fixing body defines two positioning holes in opposite ends.

8. The antenna clip as claimed in claim 7, wherein the fixing body further defines a cutout between the two opposite ends, a connecting arm is positioned in the cutout, having one end connecting to the fixing body, and an opposite end tilting and extending towards to the end of the fixing body.

9. An electronic device, comprising:
a housing;
an antenna mounted in the housing and comprising two cables;
at least one antenna clip comprising a clip body and a fixing body;
wherein the clip body comprises a base, a first wall and a second wall, the first wall and the second wall are integrally connected to opposite ends of the base and are facing towards each other, the first wall comprises at least one first resisting arm protruding from a central portion thereof towards the second wall and a limiting end bent towards the second wall, the second wall comprises at least one second resisting arm protruding from a central portion thereof towards the first wall, and a connecting end; a receiving space is formed in the clip body and is divided into several partitions by the first resisting arm and the second resisting arm for respectively clipping the cables in separate partitions; the antenna clip is secured on the housing via the fixing body.

10. The electronic device as claimed in claim 9, wherein each cable comprises at least one metal ring mounted thereon.

11. The electronic device as claimed in claim 10, wherein an opening is formed between the limiting end and the connecting end, the opening can be expanded by stretching the limiting end apart from the connected end.

12. The electronic device as claimed in claim 11, wherein the limiting end is bent towards the second wall, the fixing body is bent extending outwardly from the connecting end.

13. The electronic device as claimed in claim 12, wherein the housing comprises a bottom wall, two first partition walls and two second partition walls protruded from the bottom wall, one first partition wall defines two recesses and a plurality of posts protruding from a bottom surface of the recesses, the two recesses are adjacent to each other and are recessed towards the bottom wall, the fixing body defines two positioning holes in opposite ends, the positioning holes are engaged with the posts to secure the antenna clip to the housing.

14. The electronic device as claimed in claim 13, wherein the housing further comprises two sidewalls and two end walls, a receiving groove is formed between one second partition wall and one end wall adjacent the second partition wall, a mounting groove is formed between one sidewall and the first partition wall comprising the posts.

15. The electronic device as claimed in claim 14, wherein the antenna is received in the receiving groove, the at least one antenna clip is received in the mounting groove.

16. The electronic device as claimed in claim 15, further comprising a subsidiary circuit board, wherein the antenna further comprises a main portion, the main portion is electronically connected to the subsidiary circuit board, the two ends of the cables are electronically connected to the subsidiary circuit board and a main circuit board of the electronic device.

17. The electronic device as claimed in claim 16, wherein the fixing body further defines a cutout between the two opposite ends, a connecting arm is positioned in the cutout, having one end connecting to the fixing body, and an opposite end tilting and extending towards to the end of the fixing body, the connecting arm is electrically connected to the main circuit board.

18. The electronic device as claimed in claim 11, wherein the quantity of the first resisting arm is one, the first resisting arm is formed by cutting off a central portion of the first wall and has a side integrally connecting to the first wall and an opposite side extending towards the second wall, thus cooperatively forming a receiving space with the limiting end.

19. The electronic device as claimed in claim 18, wherein the quantity of the second resisting arm is one, the second resisting arm is formed by cutting off a central portion of the second wall and has a side integrally connecting to the second wall and an opposite side extending towards the first wall, thus cooperatively forming a receiving space with the first resisting arm.

20. The electronic device as claimed in claim 19, wherein the second resisting arm is spaced away from the first resisting arm, the first resisting arm and the second resisting arm are located between the first wall and the second wall.
